(19) United States
(12) Patent Application Publication
(10) Pub. No.: US 2005/0208268 A1
(43) Pub. Date: Sep. 22, 2005

(54) Article with ultraphobic surface

(76) Inventor: Charles W. Extrand, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/053,178

(22) Filed: Feb. 8, 2005

Related U.S. Application Data
(63) Continuation-in-part of application No. 10/454,745, filed on Jun. 3, 2003, now Pat. No. 6,852,390.
(60) Provisional application No. 60/462,963, filed on Apr. 15, 2003.

(51) Int. Cl. B32B 1/00

(52) U.S. Cl. 428/141; 428/180

(57) ABSTRACT

An article with a durable ultraphobic surface that is capable of retaining ultraphobic properties at liquid pressures of two pounds per square inch and above. The surface generally includes a substrate with a multiplicity of projecting regularly shaped microscale or nanoscale asperities disposed so that the surface has a predetermined contact line density measured in meters of contact line per square meter of surface area equal to or greater than a contact line density value “Λ_{L}” determined according to the formula:

$${Λ}_{L} = \frac{- 1 \text{,} 406}{γ cos ( {θ}_{a , 0} + ω - 90 ° )}$$

where γ is the surface tension of the liquid in Newtons per meter, θ_{a,0} is the experimentally measured true advancing contact angle of the liquid on the asperity material in degrees, and ω is the asperity rise angle in degrees.

### RELATED APPLICATIONS

This application is a continuation-in-part of co-pending U.S. Utility Patent Application Ser. No. 10/454,745, entitled ULTRAPHOBIC SURFACE FOR HIGH PRESSURE LIQUIDS, filed Jun. 3, 2003, hereby fully incorporated herein by reference, and which in turn claims the benefit of U.S. Provisional Patent Application Ser. No. 60/462,963, entitled “Ultraphobic Surface for High Pressure Liquids”, filed Apr. 15, 2003, also hereby fully incorporated herein by reference.

### FIELD OF THE INVENTION

This invention relates generally to articles having an ultraphobic surface, and more specifically to ultraphobic surfaces that exhibit ultraphobic properties at liquid pressures over two pounds per square inch.

### BACKGROUND OF THE INVENTION

Many industrial processes involve the interaction of liquids with solid surfaces. Often, it is desirable to control or influence the manner of the interaction, particularly the degree of wetting of the surface, so as to achieve a specific result. For example, surfactants are sometimes added to liquids used in cleaning processes so as to achieve greater surface wetting. In a converse example, liquid repellant coatings are sometimes added to clothing products to reduce surface wetting and accelerate drying of the clothing.

Efforts have been underway for decades to analyze and understand the principles and properties affecting surface wetting. There has been a particular interest in liquid “phobic” surfaces, which are surfaces that are resistant to wetting by liquids. Such surfaces may be referred to as hydrophobic where the liquid is water, and lyophobic relative to other liquids. If the surface resists wetting to an extent that a small droplet of water or other liquid exhibits a very high stationary contact angle with the surface (greater than about 120 degrees), if the surface exhibits a markedly reduced propensity to retain liquid droplets, or if a liquid-gas-solid interface exists at the surface when completely submerged in liquid, the surface may be generally referred to as an ultrahydrophobic or ultralyophobic surface. For the purposes of this application, the term ultraphobic is used to refer generally to both ultrahydrophobic and ultralyophobic surfaces.

Ultraphobic surfaces are of special interest in commercial and industrial applications for a number of reasons. In nearly any process where a liquid must be dried from a surface, significant efficiencies result if the surface sheds the liquid without heating or extensive drying time.

Moreover, friction between the liquid and the surface is dramatically lower for an ultraphobic surface as opposed to a conventional surface. As a result, ultraphobic surfaces are extremely desirable for reducing surface friction and increasing flow in a myriad of hydraulic and hydrodynamic applications on a macro scale, and especially in microfluidic applications.

It is now well known that surface roughness has a significant effect on the degree of surface wetting. It has been generally observed that, under some circumstances, roughness can cause liquid to adhere more strongly to the surface than to a corresponding smooth surface. Under other circumstances, however, roughness may cause the liquid to adhere less strongly to the rough surface than the smooth surface. In some circumstances, the surface may be ultraphobic.

Efforts have been made previously at introducing intentional roughness on a surface to produce an ultraphobic surface. The roughened surface generally takes the form of a substrate member with a multiplicity of microscale to nanoscale projections or cavities, referred to herein as “asperities”.

Previous attempts at producing ultraphobic surfaces with micro/nanoscale asperities have been only partially successful. Generally, while the prior art surfaces have exhibited ultraphobic properties under some circumstances relative to liquid droplets carefully placed on the surface, the properties generally disappear when a droplet is impacted with the surface.

Moreover, fluid pressure in many industrial applications where ultraphobic surfaces are desirably used often exceeds 2.0 pounds per square inch (psi), and in extreme applications, may reach hundreds of psi. Ultraphobic surfaces produced to date appear to be effective as an ultraphobic surface only up to about 1.5 psi.

Prior art ultraphobic surfaces are often formed with delicate polymer or chemical coatings deposited on the substrate. These coatings are easily physically damaged so as to be ineffective.

There is still a need in the industry for a durable ultraphobic surface that retains ultraphobic properties when impacted by liquid or under a column of liquid at pressure heads of 2 psi or more.

### SUMMARY OF THE INVENTION

In an embodiment, the invention is an article with a durable ultraphobic surface that is capable of retaining ultraphobic properties at liquid pressures of 2 psi and above. The ultraphobic surface generally includes a substrate portion with a multiplicity of projecting regularly shaped microscale or nanoscale asperities disposed so that the surface has a predetermined contact line density measured in meters of contact line per square meter of surface area equal to or greater than a contact line density value “Λ_{L}” determined according to the formula:

$${Λ}_{L} = \frac{- 1406}{γ cos ( {θ}_{a , 0} + ω - 90 ° )}$$

where γ is the surface tension of the liquid in Newtons per meter, θ_{a,0} is the experimentally measured true advancing contact angle of the liquid on the asperity material in degrees, and ω is the asperity rise angle in degrees.

The asperities may be formed in or on the substrate material itself or in one or more layers of material disposed on the surface of the substrate. The asperities may be any regularly or irregularly shaped three-dimensional solid or cavity and may be disposed in any regular geometric pattern or randomly.

The invention may also include a process for producing a surface having ultraphobic properties at liquid pressures up to a predetermined pressure value. The process includes steps of selecting an asperity rise angle; determining a critical contact line density “Λ_{L}” value according to the formula:

$${Λ}_{L} = \frac{- P}{γ cos ( {θ}_{a , 0} + ω - 90 ° )}$$

where P is the predetermined pressure value, γ is the surface tension of the liquid, and θ_{a,0} is the experimentally measured true advancing contact angle of the liquid on the asperity material in degrees, and ω is the asperity rise angle; providing a substrate member; and forming a multiplicity of projecting asperities on the substrate so that the surface has an actual contact line density equal to or greater than the critical contact line density.

The asperities may be formed using photolithography, or using nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, or by disposing a layer of parallel carbon nanotubes on the substrate. The process may further include the step of determining a critical asperity height value “Z_{c}” in meters according to the formula:

$${Z}_{c} = \frac{d ( 1 - cos ( {θ}_{a , 0} + ω - 180 ° ) )}{2 sin ( {θ}_{a , 0} + ω - 180 ° )}$$

where d is the distance in meters between adjacent asperities, θ_{a,0} is the true advancing contact angle of the liquid on the surface in degrees, and ω is the asperity rise angle in degrees.

In another embodiment, the invention is an article with an ultraphobic surface having a substrate with a hierarchical asperity structure including primary asperities on the substrate with secondary asperities on the primary asperities.

### BRIEF DESCRIPTION OF THE DRAWINGS

FIG. 1 is a perspective, enlarged view of an ultraphobic surface according to the present invention, wherein a multiplicity of nano/micro scale asperities are arranged in a rectangular array;

FIG. 2 is a top plan view of a portion of the surface of FIG. 1;

FIG. 3 is a side elevation view of the surface portion depicted in FIG. 2;

FIG. 4 is a partial top plan view of an alternative embodiment of the present invention wherein the asperities are arranged in a hexagonal array;

FIG. 5 is a side elevation view of the alternative embodiment of FIG. 4;

FIG. 6 is a side elevation view depicting the deflection of liquid suspended between asperities;

FIG. 7 is a side elevation view depicting a quantity of liquid suspended atop asperities;

FIG. 8 is a side elevation view depicting the liquid contacting the bottom of the space between asperities;

FIG. 9 is a side elevation view of a single asperity in an alternative embodiment of the invention wherein the asperity rise angle is an acute angle;

FIG. 10 is a side elevation view of a single asperity in an alternative embodiment of the invention wherein the asperity rise angle is an obtuse angle;

FIG. 11 a partial top plan view of an alternative embodiment of the present invention wherein the asperities are cylindrical and are arranged in a rectangular array;

FIG. 12 is a side elevation view of the alternative embodiment of FIG. 11;

FIG. 13 is a table listing formulas for contact line density for a variety of asperity shapes and arrangements;

FIG. 14 is a side elevation view of an alternative embodiment of the present invention;

FIG. 15 is a top plan view of the alternative embodiment of FIG. 14;

FIG. 16 is a top plan view of a single asperity in an alternative embodiment of the present invention;

FIG. 17 is a side elevation view of an alternative embodiment of the invention with a hierarchical structure of primary and secondary asperities; and

FIG. 18 is a close-up view of a portion of the side of one of the primary asperities depicted in FIG. 17.

### DETAILED DESCRIPTION OF THE INVENTION

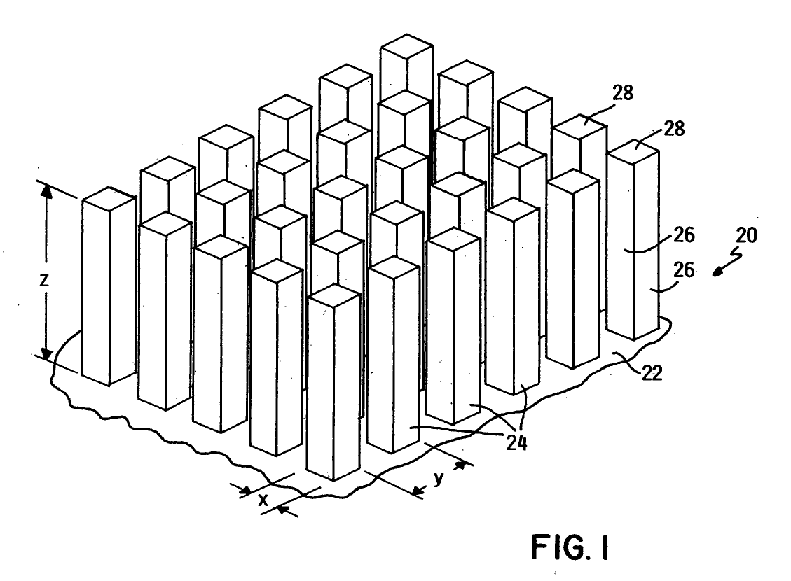

An enlarged view of an ultraphobic surface 20 according to the present invention is depicted in FIG. 1. The surface 20 generally includes a substrate 22 with a multiplicity of projecting asperities 24. Each asperity 24 has a plurality of sides 26 and a top 28. Each asperity 24 has a width dimension, annotated “x” in the figures, and a height dimension, annotated “z” in the figures.

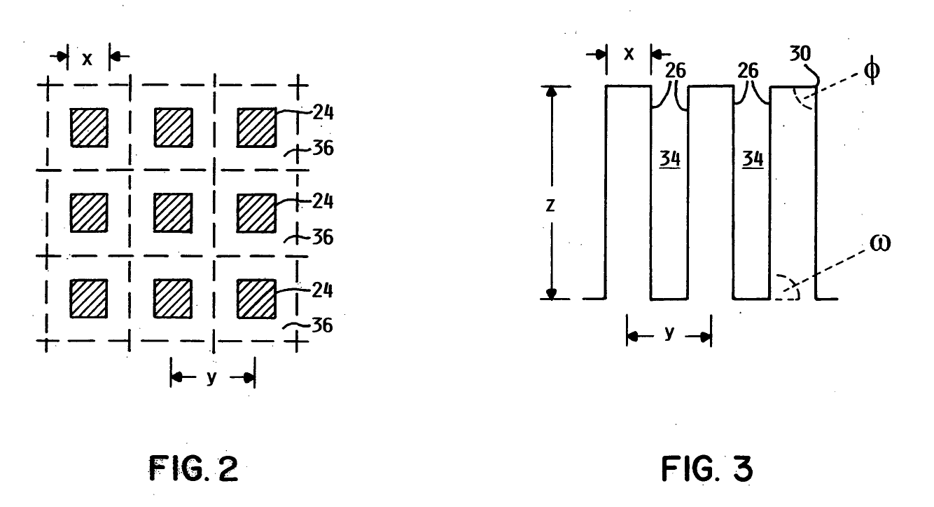

As depicted in FIGS. 1-3, asperities 24 are disposed in a regular rectangular array, each asperity spaced apart from the adjacent asperities by a spacing dimension, annotated “y” in the figures. The angle subtended by the top edge 30 of the asperities 24 is annotated φ, and the rise angle of the side 26 of the asperities 24 relative to the substrate 22 is annotated ω. The sum of the angles φ and ω is 180 degrees.

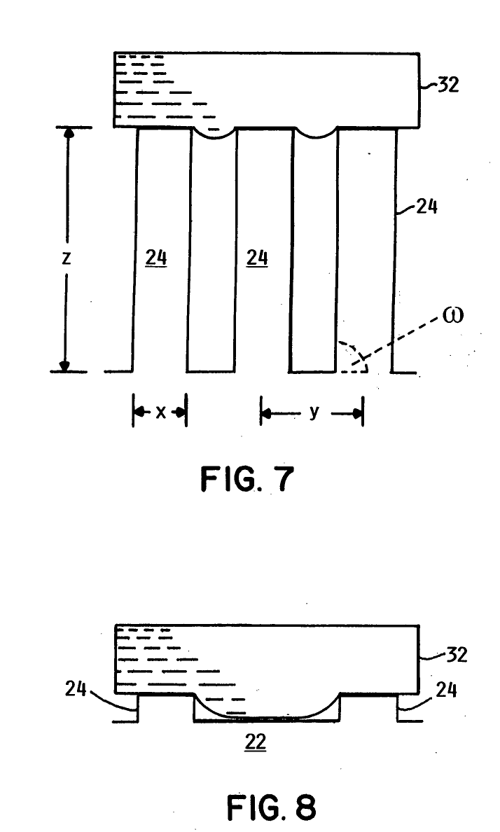

Generally, surface 20 will exhibit ultraphobic properties when a liquid-solid-gas interface is maintained at the surface. As depicted in FIG. 7, if liquid 32 contacts only the tops 28 and a portion of the sides 26 proximate top edge 30 of asperities 24, leaving a space 34 between the asperities filled with air or other gas, the requisite liquid-solid-gas interface is present. The liquid may be said to be “suspended” atop and between the top edges 30 of the asperities 24.

As will be disclosed hereinbelow, the formation of the liquid-solid-gas interface depends on certain interrelated geometrical parameters of the asperities 24 and the properties of the liquid. According to the present invention, the geometrical properties of asperities 24 may be selected so that the surface 20 exhibits ultraphobic properties at any desired liquid pressure.

Referring to the rectangular array of FIGS. 1-3, surface 20 may be divided into uniform areas 36, depicted bounded by dashed lines, surrounding each asperity 24. The area density of asperities (δ) in each uniform area 36 may be described by the equation:

$$δ = \frac{1}{2 {y}^{2}} , \qquad ( 1 )$$

where y is the spacing between asperities measured in meters.

For asperities 24 with a square cross-section as depicted in FIGS. 1-3, the length of perimeter (p) of top 28 at top edge 30:
p=4x, (2)
where x is the asperity width in meters.

Perimeter p may be referred to as a “contact line” defining the location of the liquid-solid-gas interface. The contact line density (Λ) of the surface, which is the length of contact line per unit area of the surface, is the product of the perimeter (p) and the area density of asperities (δ) so that:
Λ=p δ. (3)
For the rectangular array of square asperities depicted in FIGS. 1-3:
Λ=4x/y². (4)

A quantity of liquid will be suspended atop asperities 24 if the body forces (F) due to gravity acting on the liquid are less than surface forces (f) acting at the contact line with the asperities. Body forces (F) associated with gravity may be determined according to the following formula:
F=ρgh, (5)
where (ρ) is the density of the liquid, (g) is the acceleration due to gravity, and (h) is the depth of the liquid. Thus, for example, for a 10 meter column of water having an approximate density of 1000 kg/m³, the body forces (F) would be:
F=(1000 kg/m³)(9.8 m/s)(10 m)=9.8×10⁴ kg/m²−s.

On the other hand, the surface forces (f) depend on the surface tension of the liquid (γ), its apparent contact angle with the side 26 of the asperities 24 with respect to the vertical θₛ, the contact line density of the asperities (Λ) and the apparent contact area of the liquid (A):
f=−ΛAγ cos θₛ. (6)

The true advancing contact angle (θ_{a,0}) of a liquid on a given solid material is defined as the largest experimentally measured stationary contact angle of the liquid on a surface of the material having essentially no asperities. The true advancing contact angle is readily measurable by techniques well known in the art.

Suspended drops on a surface with asperities exhibit their true advancing contact angle value (θ_{a,0}) at the sides of the asperities. The contact angle with respect to the vertical at the side of the asperities (θₛ) is related to the true advancing contact angle (θ_{a,0}) by φ or ω as follows:
θₛ=θ_{a,0}+90°−φ=θ_{a,0+}ω−90°. (7)

By equating F and f and solving for contact line density Λ, a critical contact line density parameter Λ_{L} may be determined for predicting ultraphobic properties in a surface:

$${Λ}_{L} = \frac{- ρ gh}{γ cos ( {θ}_{a , 0} + ω - 90 ° )} , \qquad ( 8 )$$

where g is the density (ρ) of the liquid, (g) is the acceleration due to gravity, (h) is the depth of the liquid, the surface tension of the liquid (γ), ω is the rise angle of the side of the asperities relative to the substrate in degrees, and (θ_{a,0}) is the experimentally measured true advancing contact angle of the liquid on the asperity material in degrees.

If Λ>Λ_{L}, the liquid will be suspended atop the asperities 24, producing an ultraphobic surface. Otherwise, if Λ<Λ_{L}, the liquid will collapse over the asperities and the contact interface at the surface will be solely liquid/solid, without ultraphobic properties.

It will be appreciated that by substituting an appropriate value in the numerator of the equation given above, a value of critical contact line density may be determined to design a surface that will retain ultraphobic properties at any desired amount of pressure. The equation may be generalized as:

$${Λ}_{L} = \frac{- P}{γ cos ( {θ}_{a , 0} + ω - 90 ° )} , \qquad ( 9 )$$

where P is the maximum pressure under which the surface must exhibit ultraphobic properties in kilograms per square meter, γ is the surface tension of the liquid in Newtons per meter, θ_{a,0} is the experimentally measured true advancing contact angle of the liquid on the asperity material in degrees, and ω is the asperity rise angle in degrees.

It is generally anticipated that a surface 20 formed according to the above relations will exhibit ultraphobic properties under any liquid pressure values up to and including the value of P used in equation (9) above. The ultraphobic properties will be exhibited whether the surface is submerged, subjected to a jet or spray of liquid, or impacted with individual droplets.

According to the above relations, surface 20 will exhibit ultraphobic properties at a liquid pressure of 2 psi, equal to about 1406 kg/m², where the contact line density Λ of surface 20 equals or exceeds a critical contact line density Λ_{L} determined as follows:

$${Λ}_{L} = \frac{- 1406}{γ cos ( {θ}_{a , 0} + ω - 90 ° )} , \qquad ( 10 )$$

where γ is the surface tension of the liquid in Newtons per meter, θ_{a,0} is the experimentally measured true advancing contact angle of the liquid on the asperity material in degrees, and ω is the asperity rise angle in degrees.

Once the value of critical contact line density is determined, the remaining details of the geometry of the asperities may be determined according to the relationship of x and y given in the equation for contact line density. In other words, the geometry of the surface may be determined by choosing the value of either x or y in the contact line equation and solving for the other variable.

The liquid interface deflects downwardly between adjacent asperities by an amount D₁ as depicted in FIG. 6. If the amount D₁ is greater than the height (z) of the asperities 24, the liquid will contact the substrate 22 at a point between the asperities 24. If this occurs, the liquid will be drawn into space 34, and collapse over the asperities, destroying the ultraphobic character of the surface. The value of D₁ represents a critical asperity height (Z_{c}), and is determinable according to the following formula:

$${D}_{1} = {Z}_{c} = \frac{d ( 1 - cos ( {θ}_{a , 0} + ω - 180 ° ) )}{2 sin ( {θ}_{a , 0} + ω - 180 ° )} , \qquad ( 11 )$$

where (d) is the distance between adjacent asperities, ω is the asperity rise angle, and θ_{a,0} is the experimentally measured true advancing contact angle of the liquid on the asperity material. The height (z) of asperities 24 must be at least equal to, and is preferably greater than, critical asperity height (Z_{c}).

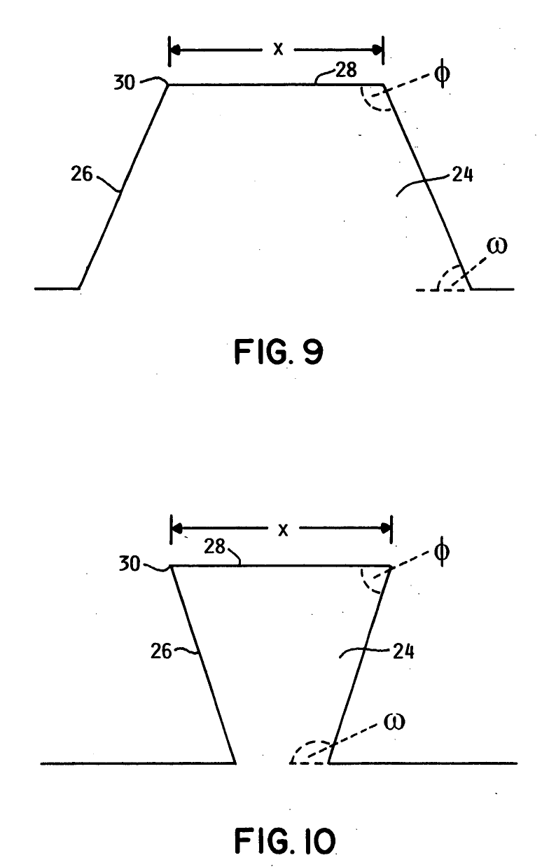

Although in FIGS. 1-3 the asperity rise angle ω is 90 degrees, other asperity geometries are possible. For example, ω may be an acute angle as depicted in FIG. 9 or an obtuse angle as depicted in FIG. 10. Generally, it is preferred that ω be between 80 and 130 degrees.

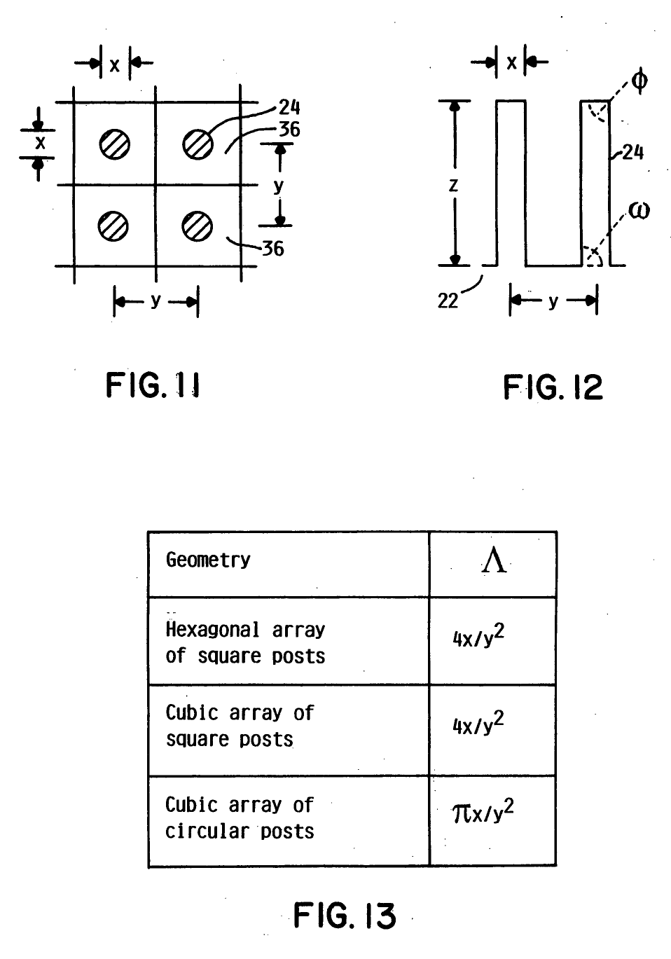

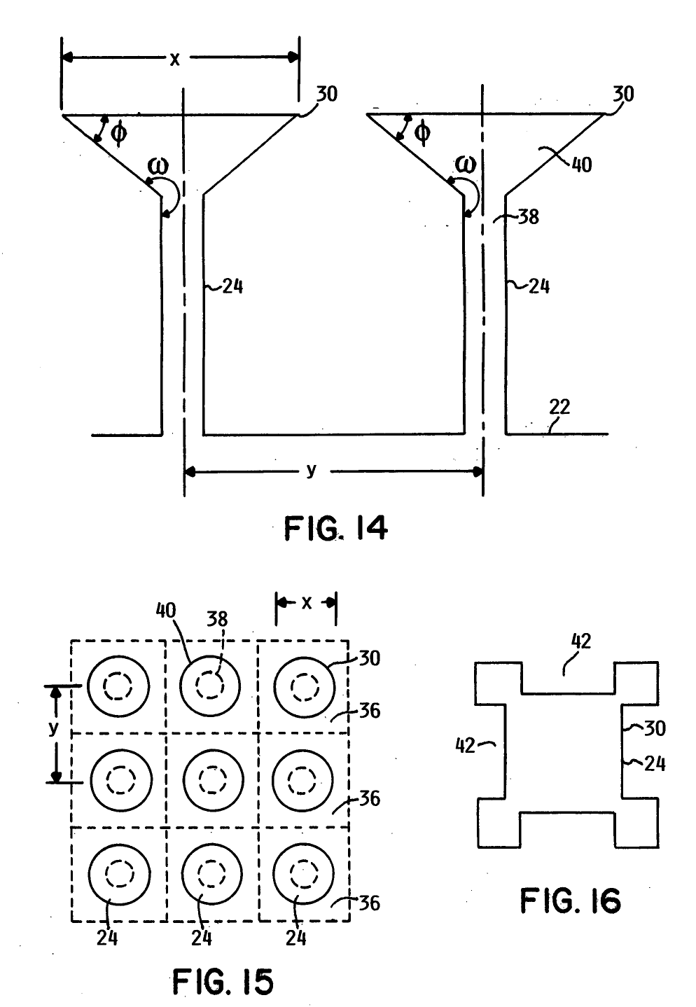

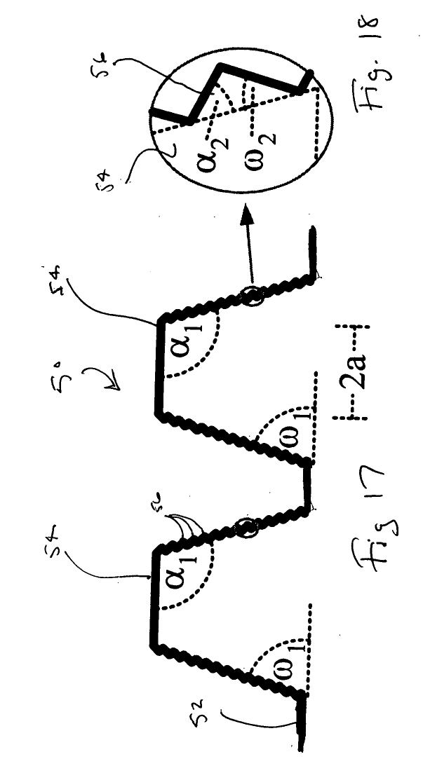

It will also be appreciated that a wide variety of asperity shapes and arrangements are possible within the scope of the present invention. For example, asperities may be polyhedral, cylindrical as depicted in FIGS. 11-12, cylindroid, or any other suitable three dimensional shape. In addition, various strategies may be utilized to maximize contact line density of the asperities. As depicted in FIGS. 14 and 15, the asperities 24 may be formed with a base portion 38 and a head portion 40. The larger perimeter of head portion 40 at top edge 30 increases the contact line density of the surface. Also, features such as recesses 42 may be formed in the asperities 24 as depicted in FIG. 16 to increase the perimeter at top edge 30, thereby increasing contact line density. The asperities may also be cavities formed in the substrate.

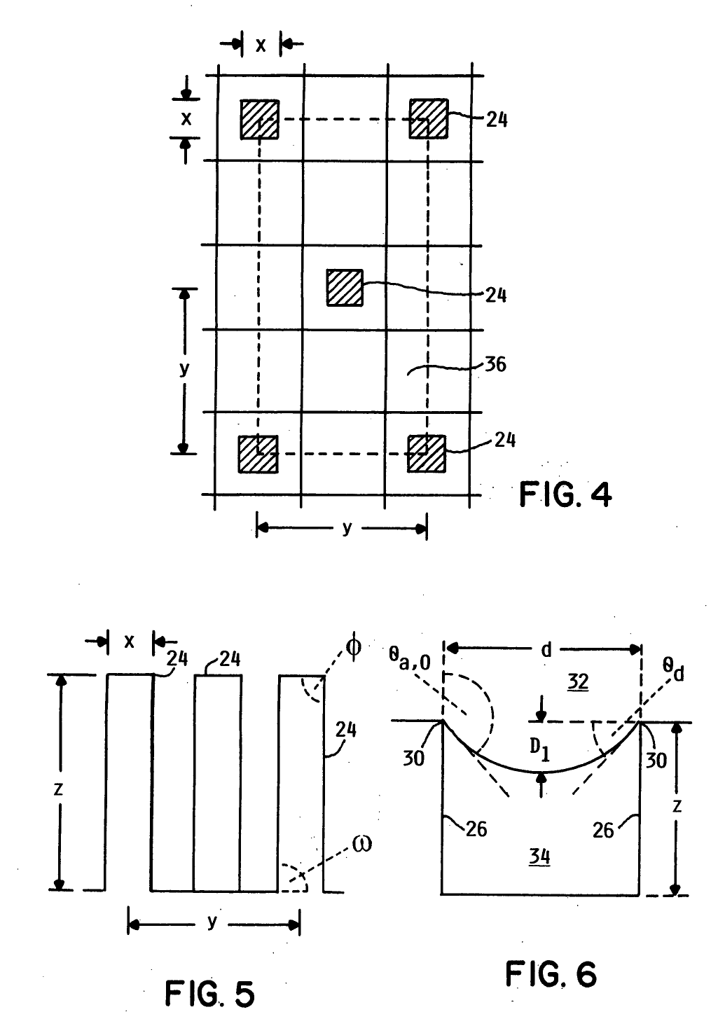

The asperities may be arranged in a rectangular array as discussed above, in a polygonal array such as the hexagonal array depicted in FIGS. 4-5, or a circular or ovoid arrangement. The asperities may also be randomly distributed so long as the critical contact line density is maintained, although such a random arrangement may have less predictable ultraphobic properties, and is therefore less preferred. In such a random arrangement of asperities, the critical contact line density and other relevant parameters may be conceptualized as averages for the surface. In the table of FIG. 13, formulas for calculating contact line densities for various other asperity shapes and arrangements are listed.

Generally, the substrate material may be any material upon which micro or nano scale asperities may be suitably formed. The asperities may be formed directly in the substrate material itself, or in one or more layers of other material deposited on the substrate material, by photolithography or any of a variety of suitable methods. A photolithography method that may be suitable for forming micro/nanoscale asperities is disclosed in PCT Patent Application Publication WO 02/084340, hereby fully incorporated herein by reference.

Other methods that may be suitable for forming asperities of the desired shape and spacing include nanomachining as disclosed in U.S. Patent Application Publication No. 2002/00334879, microstamping as disclosed in U.S. Pat. No. 5,725,788, microcontact printing as disclosed in U.S. Pat. No. 5,900,160, self-assembled metal colloid monolayers, as disclosed in U.S. Pat. No. 5,609,907, microstamping as disclosed in U.S. Pat. No. 6,444,254, atomic force microscopy nanomachining as disclosed in U.S. Pat. No. 5,252,835, nanomachining as disclosed in U.S. Pat. No. 6,403,388, sol-gel molding as disclosed in U.S. Pat. No. 6,530,554, self-assembled monolayer directed patterning of surfaces, as disclosed in U.S. Pat. No. 6,518,168, chemical etching as disclosed in U.S. Pat. No. 6,541,389, or sol-gel stamping as disclosed in U.S. Patent Application Publication No. 2003/0047822, all of which are hereby fully incorporated herein by reference. Carbon nanotube structures may also be usable to form the desired asperity geometries. Examples of carbon nanotube structures are disclosed in U.S. Patent Application Publication Nos. 2002/0098135 and 2002/0136683, also hereby fully incorporated herein by reference. Also, suitable asperity structures may be formed using known methods of printing with colloidal inks, and tunneling electron microscopy. Of course, it will be appreciated that any other method by which micro/nanoscale asperities may be accurately formed may also be used.

It is anticipated that the ultraphobic surface of the present invention will be usefully applied to myriad articles. For example, it is anticipated that if ultraphobic surfaces are applied on the wetted portions of fluid handling systems such as piping, tubing, fittings, valves and other devices, significant reduction in fluid friction and turbulance may be achieved. Similarly, flow impedance in microfluidic devices may be reduced by a reduction in viscous and surface forces resulting from ultraphobic wetted surfaces. Effectiveness of critical cleaning processes may be improved by faster drying times and less chemical carryover residue remaining on the surface after drying. It is also anticipated that ultraphobic surfaces according to the present invention will be resistant to the growth of organisms in a bio-film on the surface, due in part to the greatly improved drainability of the surface. Further, due to the liquid-solid-gas interface at the surface, it is anticipated that the ultraphobic surface of the present invention may be applied to a gas transfer membrane to improve the effectiveness of gas transfer in and out of a liquid. U.S. Pat. No. 6,845,788 entitled FLUID HANDLING COMPONENT WITH ULTRAPHOBIC SURFACES; and co-pending U.S. Utility patent application Ser. Nos. 10/454,740 entitled TRAY CARRIER WITH ULTRAPHOBIC SURFACES; 10/454,743 entitled CARRIER WITH ULTRAPHOBIC SURFACES; 10/662,979 entitled FUEL CELL WITH ULTRAPHOBIC SURFACES; 10/652,586 entitled MICROFLUDIC DEVICE WITH ULTRPHOBIC SURFACES; and 10/824,340 entitled ULTRALYOPHOBIC MEMBRANE, disclose various useful applications of the present invention, and are all hereby fully incorporated herein by reference.

### EXAMPLE

A surface is desired that will exhibit ultraphobic characteristics under water pressures of up to 10 atmospheres. The desired surface geometry is a rectangular array of elongate polyhedrons having a generally square cross-section and an asperity rise angle of 90 degrees. The asperities are to be formed, using photolithography, in a silicon substrate, which will be treated with organosilanes after the asperities are formed. The experimentally measured true advancing contact angle of water on an organosilane treated silicon substrate without asperities is approximately 110 degrees. The surface tension of pure water is approximately 0.073 Newtons per square meter. The critical contact line density for such a surface may be determined as follows:

$$\begin{matrix}{Λ}_{L} = \frac{- 103 \text{,} 300}{γ cos ( {θ}_{a , 0} + ω - 90 ° )} \\ = \frac{- 103 \text{,} 300}{0.073 cos ( 110 ° + 90 ° - 90 ° )} \\ = 4.1 \times {10}^{6} m \text{/} {m}^{2}\end{matrix}$$
Selecting an asperity width of 20 nm, the contact line equation for a rectangular array of square polyhedrons may be used to solve for the required asperity spacing:

$$y = \sqrt{\frac{4 x}{Λ}} = \sqrt{\frac{4 ( 2 \times {10}^{- 8} )}{4.1 \times {10}^{6}}} = 139 nm$$
The critical asperity height (Z_{c}) is determined as:

$$\begin{matrix}{Z}_{c} = \frac{d ( 1 - cos ( {θ}_{a , 0} + ω - 180 ° ) )}{2 sin ( {θ}_{a , 0} + ω - 180 ° )} \\ = \frac{( .000000139 - .00000002 ) cos ( 110 ° + 90 ° - 180 ° )}{2 sin ( 110 ° + 90 ° - 180 ° )} \\ = 163 nm\end{matrix}$$
Thus, in one configuration, the surface will comprise a rectangular array of projecting elongate polyhedrons having a generally square cross section, wherein the polyhedrons are 20 nm in width and spaced no more than about 139 nm apart. The polyhedrons should be more than 163 nm in height.

Of course, a different surface geometry results if the selected asperity width is 50 nm:

$$y = \sqrt{\frac{4 x}{Λ}} = \sqrt{\frac{4 ( 5 \times {10}^{- 8} )}{4.1 \times {10}^{6}}} = 220 nm and \text{:} \\ {Z}_{c} = \frac{( .000000220 - .00000005 ) cos ( 110 ° + 90 ° - 180 ° )}{2 sin ( 110 ° + 90 ° - 180 ° )} \\ = 234 nm$$

In this configuration, the surface will comprise a rectangular array of projecting elongate polyhedrons having a generally square cross section, wherein the polyhedrons are 50 nm in width and spaced no more than about 220 nm apart. The polyhedrons should be more than 234 nm in height.

FIG. 17 is a side elevation view of an alternative embodiment of an ultraphobic surface 50 according to the invention. Ultraphobic surface 50 generally includes a substrate 52 with a hierarchical structure including a multiplicity of generally uniformly shaped and distributed primary asperities 54 and a multiplicity of generally uniformly shaped secondary asperities 56 distributed on each of the primary asperities 54. As depicted, primary asperities 54 may be frusto-conical with a top surface radius denoted by “a”, a substrate rise angle ω₁ and a top angle α₁, the sum of which amounts to 180 degrees. FIG. 18 is an enlarged view of the side surface 56 of primary asperity 54, depicting the geometric structure of secondary asperities 56 in further detail. Each of secondary asperities 56 defines a rise angle ω₂ from the primary asperity 54 from which it projects and a subtended angle α₂. The overall asperity rise angle ω for surface 50 is calculated as:
ω=ω₁₊ω₂ (12)
The calculated value of ω from equation (12) may then be used in equations (9), (10), and (11) to determine critical contact line density and critical asperity height for surface 50. It will be appreciated that, for surfaces with a hierarchical asperity structure, such with surface 50, the geometry of the secondary asperities, especially the overall asperity rise angle ω, is influential in determining the ultraphobic character and wetting properties of the surface. A hierarchical structure may accordingly be beneficial in optimizing the ultraphobic properties of the surface by enabling overall asperity rise angles ω that would be difficult or impossible to practically achieve with only a single uniform arrangement of asperities.

It will be appreciated that the hierarchical structure of surface 50 may be beneficially used in applications where ultraphobic surface properties are desired for lower values of P, as for example where the liquid contact may be in the form of droplets on the surface. In these applications, the value of P must be selected to account for the smaller apparent contact area of a droplet as opposed to a uniform layer of liquid. In general, the apparent contact area (A) in square meters of a small droplet on the surface is given by the relation:

$$A = {{π}^{\frac{1}{3}} ( 6 V )}^{\frac{2}{3}} {( ( \frac{( 1 - cos {θ}_{a} )}{ sin {θ}_{a}} ) ( 3 + {( \frac{( 1 - cos {θ}_{a} )}{sin {θ}_{a}} )}^{2} ) )}^{- \frac{2}{3}} , \qquad ( 13 )$$

where V is the volume of the droplet in cubic meters, and θₐ is the apparent advancing contact angle of the droplet on the surface. The critical contact line density Λ_{L} parameter for suspending a droplet on the surface 50 becomes:

$${Λ}_{L} = \frac{- ρ {g ( V )}^{\frac{1}{3}} {( ( \frac{( 1 - cos {θ}_{a} )}{sin {θ}_{a}} ) ( 3 + {( \frac{( 1 - cos {θ}_{a} )}{sin {θ}_{a}} )}^{2} ) )}^{2 / 3}}{{( 36 π )}^{\frac{1}{3}} γ cos ( {θ}_{a , 0} + ω - 90 ° )} , \qquad ( 14 )$$

where V is the volume of the droplet in cubic meters, g is the density (ρ) of the liquid, (g) is the acceleration due to gravity, (h) is the depth of the liquid, the surface tension of the liquid (γ), ω is the overall rise angle of the asperities as calculated from equation (11), θₐ is the apparent advancing contact angle of the droplet on the surface, and (θ_{a,0}) is the experimentally measured true advancing contact angle of the liquid on the asperity material in degrees. Equation 14 may be useful to check the value of P selected for low pressure ultraphobic surfaces to ensure that the surface will suspend droplets.

1. An article with an ultraphobic surface comprising:
a substrate having a surface with a multiplicity of substantially uniformly shaped asperities thereon, each asperity having a common asperity rise angle relative to the substrate, the asperities positioned so that the surface has a contact line density measured in meters of contact line per square meter of surface area equal to or greater than a contact line density value “Λ_{L}” determined according to the formula:
$${Λ}_{L} = \frac{- 1 \text{,} 406}{γ cos ( {θ}_{a , 0} + ω - 90 ° )}$$
where γ is the surface tension of a liquid in contact with the surface in Newtons per meter, θ_{a,0} is the experimentally measured true advancing contact angle of the liquid on the asperity material in degrees, and ω is the asperity rise angle in degrees, wherein the surface exhibits a liquid-solid-gas interface with the liquid at a pressure of at least two pounds per square inch.

2. The article of claim 1, wherein the asperities are projections.

3. The article of claim 2, wherein the asperities are polyhedrally shaped.

4. The article of claim 2, wherein each asperity has a generally square transverse cross-section.

5. The article of claim 2, wherein the asperities are cylindrical or cylindroidally shaped.

6. The article of claim 1, wherein the asperities are cavities formed in the substrate.

7. The article of claim 1, wherein the asperities are positioned in a substantially uniform array.

8. The article of claim 7, wherein the asperities are positioned in a rectangular array.

9. The article of claim 1, wherein the asperities have a substantially uniform asperity height relative to the substrate portion, and wherein the asperity height is greater than a critical asperity height value “Z_{c}” in meters determined according to the formula:
$${Z}_{c} = \frac{d ( 1 - cos ( {θ}_{a , 0} + ω - 180 ° ) )}{2 sin ( {θ}_{a , 0} + ω - 180 ° )}$$
where d is the distance in meters between adjacent asperities, θ_{a,0} is the experimentally measured true advancing contact angle of the liquid on the asperity material in degrees, and ω is the asperity rise angle in degrees.

10. An article having an ultraphobic surface portion comprising a substrate with a multiplicity of substantially uniformly shaped primary asperities thereon, each primary asperity defining a common primary asperity rise angle relative to the substrate, each primary asperity having a multiplicity of substantially uniformly shaped secondary asperities thereon, each secondary asperity defining a common secondary asperity rise angle relative to the surface of the primary asperity, the primary and secondary asperities positioned so that the ultraphobic surface defines a contact line density measured in meters of contact line per square meter of surface area equal to or greater than a contact line density value “Λ_{L}” determined according to the formula:
$${Λ}_{L} = \frac{- P}{γ cos ( {θ}_{a , 0} + ω - 90 ° )}$$
where γ is the surface tension of a liquid in contact with the surface in Newtons per meter, θ_{a,0} is the experimentally measured true advancing contact angle of the liquid on the asperity material in degrees, ω is the sum of the primary asperity rise angle and the secondary asperity rise angle in degrees, and P is a predetermined liquid pressure value in kilograms per meter, wherein the ultraphobic surface exhibits a liquid-solid-gas interface with the liquid at liquid pressures up to and including the predetermined liquid pressure value.

11. The article of claim 10, wherein the liquid contacting the surface is in the form of droplets, and the critical contact line density “Λ_{L}” is determined according to the formula:
$${Λ}_{L} = \frac{- ρ {g ( V )}^{\frac{1}{3}} {( ( \frac{( 1 - cos {θ}_{a} )}{sin {θ}_{a}} ) ( 3 + {( \frac{( 1 - cos {θ}_{a} )}{sin {θ}_{a}} )}^{2} ) )}^{2 / 3}}{{( 36 π )}^{\frac{1}{3}} γ cos ( {θ}_{a , 0} + ω - 90 ° )} ,$$
where V is the volume of the droplet in cubic meters, g is the density (ρ) of the liquid in kilograms per cubic meter, (g) is the acceleration due to gravity in meters per second squared, (h) is the depth of the liquid in meters, (γ) is the surface tension of the liquid in Newtons per meter, ω is the sum of the primary asperity rise angle and the secondary asperity rise angle in degrees, θₐ is the apparent advancing contact angle of the droplet on the surface, and (θ_{a,0}) is the experimentally measured true advancing contact angle of the liquid on the asperity material in degrees.

12. The article of claim 10, wherein the primary asperities are frusto-conical projections.

13. A process of making an article with an ultraphobic surface adapted for repelling a liquid at a pressure of at least two pounds per square inch in contact with the surface, the process comprising:
providing an article comprising a substrate defining an outer surface; and
forming a multiplicity of substantially uniformly shaped asperities on the outer surface of the substrate, each asperity having a common asperity rise angle relative to the substrate, the asperities positioned so that the surface has a contact line density measured in meters of contact line per square meter of surface area equal to or greater than a contact line density value “Λ_{L}” determined according to the formula:
$${Λ}_{L} = \frac{- 1 \text{,} 406}{γ cos ( {θ}_{a , 0} + ω - 90 ° )}$$
where γ is the surface tension of the liquid in Newtons per meter, is the experimentally measured true advancing contact angle of the liquid on the asperity material in degrees, and ω is the asperity rise angle in degrees.

14. The process of claim 13, wherein the asperities are formed by photolithography.

15. The process of claim 13, wherein the asperities are formed by a process selected from the group consisting of nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, and disposing a layer of parallel carbon nanotubes on the substrate.
